(19) United States
(12) Patent Application Publication
(10) Pub. No.: US 2014/0337985 A1
(43) Pub. Date: Nov. 13, 2014

(54) Security in Digital Manufacturing Systems

(71) Applicant: Jorge Enrique Muyshondt, Leander, TX (US)

(72) Inventor: Jorge Enrique Muyshondt, Leander, TX (US)

(21) Appl. No.: 13/921,007

(22) Filed: Jun. 18, 2013

Related U.S. Application Data
(60) Provisional application No. 61/821,182, filed on May 8, 2013.

(51) Int. Cl. G06F 21/60

(52) U.S. Cl. CPC G06F 21/602
USPC 726/26

(57) ABSTRACT

A system for digital manufacturing is described. A content repository includes digital manufacturing source files that have model information, pricing information, and rights information. A viewport for viewing a visual rendering of the digital manufacturing source file is included along with an obfuscation engine for obfuscating the digital manufacturing source file at the content repository and de-obfuscating the digital manufacturing source file at the viewport. Also included is a selection engine for choosing the digital manufacturing source file for digital manufacturing.

### RELATED APPLICATIONS

This application claims benefit from the provisional application, U.S. Ser. No. 61/821,182 filed on May 8, 2013.

### FIELD OF THE DISCLOSURE

The present disclosure relates generally to digital manufacturing systems and more particularly to improvement of security systems related to the operation of such digital manufacturing systems.

### BACKGROUND

With the increased penetration of digital manufacturing systems (including without limitation CNC machines and 3-D printers) into multiple markets, the applications and customers of digital manufacturing systems continue to grow. Previously, digital manufacturing systems were extremely expensive and were often reserved for specific industrial and commercial use in controlled areas. Digital manufacturing systems are now used in shared environments with multiple users using the same resources for multiple applications. Often the digital manufacturing system may be located off-site in a central location and operated by an entity different from the entity seeking a manufactured product. Further, there may be multiple digital manufacturing systems available to consumers where each manufacturing device offers a different combination of desired technical capability, speed, location, price point or other key characteristics.

As a result of this development, digital manufacturing systems have evolved from a “singer-user to single-device” model where only one user accesses only one digital manufacturing device to a “many-users to many-devices” model where multiple users have access to multiple digital manufacturing devices. With this usage model, the need for increased security in digital manufacturing systems along with a robust easy-to-use interface is more important than before.

Since confidential information of multiple parties may now be transmitted through the same resources and conduits in a modern digital manufacturing systems, there is a pressing need for a robust security system that protects necessary confidential information while allowing for user flexibility and access. This drives the need for security for digital manufacturing systems at multiple points within the digital manufacturing system. Content providers will not want to provide confidential data files for digital manufacturing systems without assurance that their content will be kept confidential and that they will be properly compensated for the use of their content.

Multiple layers of security may be desired within modern day digital manufacturing systems. First, the information related to each authorized user may be kept confidential. Second, the information related to the raw data related to digital manufacturing system files may be kept confidential both in a content repository and as the information is transmitted within a digital manufacturing system network infrastructure. Third, the information related to which users access which digital manufacturing system files may be kept confidential. Other areas of security may also be needed in combination with the foregoing or standing alone.

Accordingly, there is a need for an improved security system for digital manufacturing systems that protects the confidential nature of the digital manufacturing system-related data within a digital manufacturing system networking system while preserving a robust and easy-to-use interface for the users and content creators. This may provide a full end-to-end content ecosystem for digital manufacturing systems, whereby the model files are not directly accessible to the end user and protected by some combination of one or more methods including, but not limited to, proprietary instruction languages, proprietary file formats, encryption, and account authentication.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a secure digital manufacturing system in accordance with some embodiments.

FIG. 2A is a server-side flowchart within a secure digital manufacturing system in accordance with some embodiments.

FIG. 2B is a manufacture-side flowchart within a secure digital manufacturing system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The embodiments described herein include a content repository having a digital manufacturing source file, a viewport for viewing a visual rendering of the digital manufacturing source file, an obfuscation engine for obfuscating the digital manufacturing source file at the content repository and de-obfuscating the digital manufacturing source file at the viewport, and a selection engine for choosing the digital manufacturing source file for digital manufacturing.

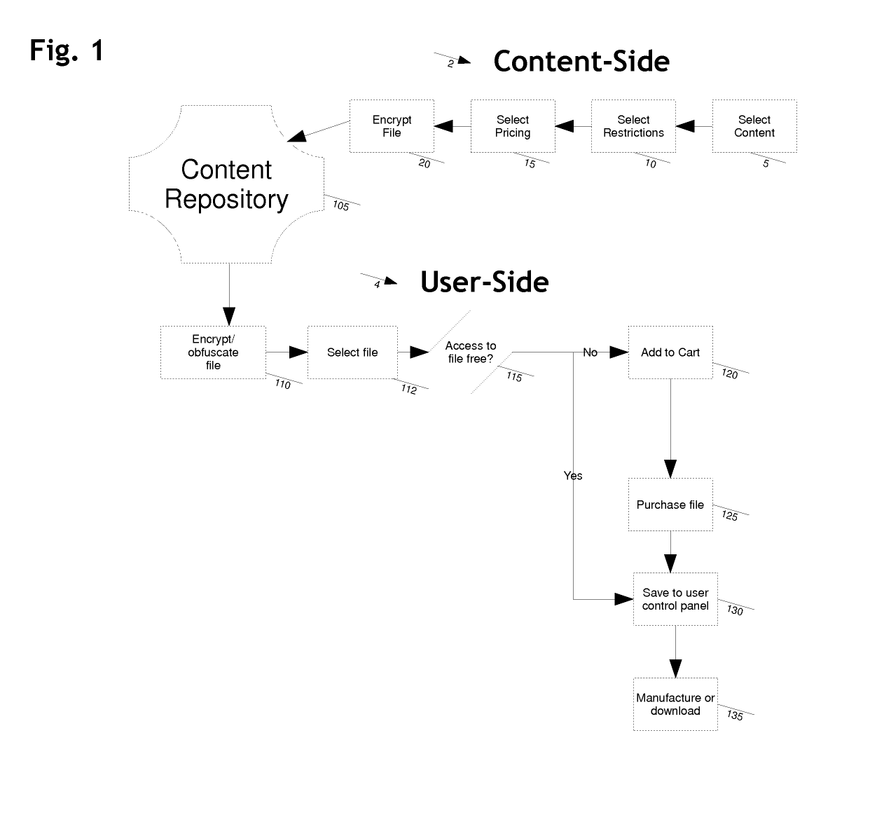

Turning to FIG. 1, shown is a block diagram of a secure digital manufacturing system in accordance with some embodiments. A content repository 105 includes multiple native model files or data necessary to instruct digital manufacturing systems on making devices or goods. The content repository may be populated with digital manufacturing system files using the content-side mechanisms 2. The content repository 105 may or may not be located in proximity to any or all steps related to the content-side mechanism 2 or the user-side mechanism 4. The steps may be physically networked or virtually networked over the Internet or other networks.

On the content-side mechanisms 2, one or more contributors of digital manufacturing system files selects which such files 5 will be placed into the content repository 105 after authenticating with the system. The contributor may then select various restrictions 10 related to one or more of the files. The restrictions may include attributes related to user access, manufacturing device type needed and the like. The contributor may then select pricing attributes 15 for the various files being placed in the content repository 105. Pricing schemes may include a fee-free scheme or a fee-based scheme that is fixed or variable depending on the file type or user. The contributor may then choose to encrypt the file 20 prior to be being placed in the content repository 105.

Each file for digital manufacturing of an object may be associated with raw data that may be referred to as the “point cloud.” This raw data includes a stream of points that consists of point information and face information, which may be necessary for constructing a proper “STL” file. STL (also known as Standard Tessellation Language) is a file format that is supported by many software packages and is widely used for rapid prototyping and computer-aided manufacturing. As an example, this point information describes a raw unstructured triangulated surface by the unit normal and vertices (ordered by the right-hand rule) of the triangles using a three-dimensional Cartesian coordinate system. Coordinates may be positive numbers, there is no scale information, and the units are arbitrary. To display the 3D model on the client, points must be converted to faces. A face is a collection of three indices into an array. This information creates the triangles that make up the 3D model and allow it to be displayed on the client.

STL files may be viewed in a standard text editor; an exemplary point cloud is in the following format:

. . .
facet normal −1.000000e+000−1.355573e−015−0.000000e+000
outer loop
vertex −5.500000e+000−1.865521e+001 6.345205e+001
vertex −5.500000e+000−1.800000e+001 6.350000e+001
vertex −5.500000e+000−1.800000e+001 6.150000e+001
endloop
endfacet
facet normal −1.000000e+000−4.337941e−017 4.404386e−016
outer loop
vertex −5.500000e+000−1.848773e+001 6.145196e+001
vertex −5.500000e+000−1.865521e+001 6.345205e+001
vertex −5.500000e+000−1.800000e+001 6.150000e+001
endloop
endfacet

With the information in an STL file, it is trivial to recreate the model it represents. Unfettered access to the STL file creates problems for content owners who wish to share or sell their files while prevent mass proliferation of their content over the Internet or other media. Thus, the access of model files by the client may be further restricted so that the raw data of the model files is not directly accessible by the user.

Moreover, while STL files are the most common file type used for digital manufacturing, the same principles and security drawbacks also apply for any such digital manufacturing file format, including but not limited to STEP, OBJ, and IGES files.

For the user-side mechanism 4, once files are loaded into the content repository 105, each file may be directed to be used on a particular type or class of manufacturing device and may be directed to a particular class of good to be manufactured. The file may include identifying attributes including file type, file size, cost information, manufacturing device needed, copyright information, author information and the like. The files may be indexed to allow for efficient searching. The files themselves may be encrypted at this stage so as to prevent improper access by unauthorized users. The system may further be designed so that the user is not able to access the raw manufacturing data in the file at any time during the operation of the system.

After authenticating with the system, a user may access the files in the content repository 105 to determine which of the files to manufacture. The access may take place over the Internet or on site and may take place via a graphical user interface. The user selects one or more model files to download or manufacture 112. The user may view or create a model through the web using their own device or machine, which may be referred to as a viewport. The viewport may also allow for increased interactivity allowing users to view and rotate their models. The viewport may also be used for file manipulation, such as scaling, rotation, customization and the like as well as a tool for interfacing with digital manufacturing systems by serving as a “print preview” window for model positioning and the like. The viewport may provide an overview of the file, including pre-rendered images of the 2D or 3D model, a description, pricing, and other such elements. Upon viewing of the file, the user may choose to alter attributes of the model to be manufactured. The viewport may provide the capability to provide a 2D or 3D preview of such changes.

Upon a request by the client to the content repository 105 (also called the server), the server may respond by retrieving and sending the client the requested information that may be manifested as a web page in the viewport. This data may be encrypted and obfuscated, and then may be passed on to a proprietary file format on the server to prevent unauthorized access to the raw model data (point cloud). Encryption may be done via by a variety of different methods, including, but not limited to, AES, AES, Blowfish, DES, Triple DES, Serpent and Twofish. Obfuscation is a form of data masking that scrambles the file data, rendering it unintelligible and unusable. This two-step process (obfuscation plus encryption) means that if a user is able to break the encryption, break into the viewport application, and obtain access to the obfuscated file, it is still very non-trivial to de-obfuscate the data into a usable file type. Thus, security for the raw data in the content repository 105 is increased.

Simultaneous de-obfuscation and rendering may also occur locally on the client's GPU. Security is further increased by the fact this data is difficult to fetch from the GPU. It is a highly non-trivial undertaking to attempt to extract the un-obfuscated data from the GPU's memory while calculations to de-obfuscate and render the data are being done. After de-obfuscation, the viewport may see the original point data and then provide a visual representation of the model to the user.

Once the user has chosen the file to manufacture, based on the attributes of the particular file the repository interface then determines 115 if there a cost to manufacture the model file. If there is such a cost, the user adds the model file to a cart 120 and then purchases the right to download or manufacture the model file 125. The model file is then saved to the user control panel 130. If the model file is free, the right to download or manufacture the model file is saved to the user control panel 130 directly. In either case, the user may thereafter 135 download the model file for later manufacture or send it to a digital manufacturing system for manufacture of the model at that time, depending on the rights terms of the model. Further, when a user purchases or otherwise gains access to model manufacturing rights, his or her rights may be stored on his or her account, and he or she can then manufacture that model on any of the devices he or she may access that are associated with his or her account.

The model file may be encrypted at this stage prior to downloading or transmission. Alternatively, digital rights management techniques may be applied to the model file to prevent unauthorized use. Alternatively, the model file that is transmitted to the manufacturing device may be restricted to include only that information necessary to instruct the digital manufacturing device to manufacture the model in question. In such a case, the instruction information is restricted to only that information that is necessary for the manufacturing device to print the model. Thus, if the instruction information is improperly accessed, it is difficult or impossible to reverse-engineer such instruction information to produce the original raw data for the model.

Once a model file or model files have been chosen by a user (either through the systems described above or through another method) a system is engaged to produce the model resulting from that model file. Such a manufacturing system may require two steps, a server-side system and manufacture-side system.

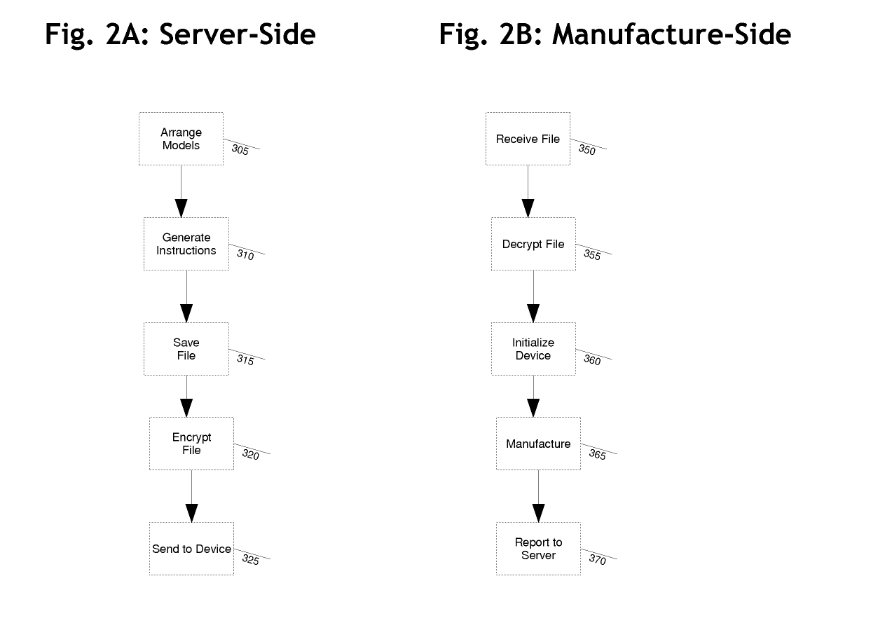

FIG. 2A demonstrates steps related to a server-side system. Once a digital manufacturing system is selected, the file is read to determine which models must be arranged in order to manufacture the desired object 305. The files may also be “sliced”, generating an instruction set for manufacturing the model. From the model arrangement, the server-side system generates the instructions necessary to produce the desired object 310. These instructions are specific to the chosen digital manufacturing system and are arranged in such a fashion that it is difficult to take these instructions and reconstruct the model file. The instructions are then saved in a file 315 that may be encrypted 320 and then sent to the manufacture-side system 325.

This instruction set may be readable by digital manufacturing devices using open-source or proprietary technology. Alternatively, the instruction set may be proprietary and is readable only with predetermined device firmware for specific digital manufacturing devices. The instruction set may then encrypted, and transmitted (possibly via the Internet) to the digital manufacturing system—either directly to a network-attached manufacturing device, or through “client software” that runs on a local computer that has access to the manufacturing device.

FIG. 2B demonstrates steps regarding the manufacture-side system. Once a digital manufacturing system file is received by the manufacture-side system 350, the file is decrypted 355. The digital manufacturing device is initialized 360 and then the object is manufactured 365. Once the manufacture is completed, the status is reported back to the server-side system 370. Progress data from the manufacture may be continuously uploaded to the server to show manufacture status, and may include features for error reporting and diagnostics

The foregoing content ecosystem may be used in a variety of configurations. The system may work with a variety of digital manufacturing systems with different manufacturers. The system may work whereby instructions for digital manufacturing are generated on either a web server, or on software installed on a user's computer, or on the manufacturing device itself. The system may work whereby the digital manufacturing systems may be controlled through any combination of the following: over a USB, Ethernet, or WiFi connection, via either a direct connection to a computer, over a Local Area Network, via an ad-hoc network, or over the internet, from any variety of electronic devices including, but not limited to, computers, smartphones, and tablets, or from any web browser. The system may work with ability to control and manage a digital manufacturing system from either the digital manufacturing system itself, or from a variety of different devices, including, but not limited to, computers, tablets, or smartphones, either via an internet site, or through software running on the devices themselves. This system may also be used for any kind of digital fabrication technology, including CNC machining, 3-D printing and any other manufacturing technologies that take digital files and turn them into manufacturing instructions.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. An apparatus comprising:
a content repository having a digital manufacturing source file, wherein the digital manufacturing source file comprises model attributes;
a viewport for viewing a visual rendering of the digital manufacturing source file based on the model attributes;
an obfuscation engine for obfuscating the digital manufacturing source file at the content repository and de-obfuscating the digital manufacturing source file at the viewport; and
a selection engine for choosing the digital manufacturing source file for digital manufacturing.

2. The apparatus as in claim 1 further comprising an encryption engine for encrypting the digital manufacturing source file at the content repository and decrypting the digital manufacturing source file at the viewport.

3. The apparatus as in claim 2 wherein the digital manufacturing source further comprises price attributes.

4. The apparatus as in claim 3, further comprising a purchasing mechanism that is associated with the price attributes of the digital manufacturing source file.

5. The apparatus as in claim 2 wherein the digital manufacturing source further comprises rights attributes.

6. The apparatus as in claim 5, further comprising a security mechanism that is associated with the rights attributes of the digital manufacturing source file.

7. The apparatus as in claim 2, further comprising a manipulation mechanism for viewing multiple visual renderings of the digital manufacturing source file.

8. The apparatus as in claim 7, further comprising a transformation engine for transforming the digital manufacturing source file to a digital manufacturing instruction file, wherein the digital manufacturing instruction file is associated with a specific model of digital manufacturing device.

9. The apparatus as in claim 8, further comprising a first transmission mechanism for transferring the digital manufacturing instruction file to a digital manufacturing device server.

10. The apparatus as in claim 9, further comprising a second transmission mechanism for transferring the digital manufacturing instruction from the digital manufacturing device server to a digital manufacturing device.

11. A method comprising:
storing a digital manufacturing source file in a content repository, wherein the digital manufacturing source file comprises model attributes;
viewing a visual rendering of the digital manufacturing source file based on the model attributes on a viewport;
obfuscating the digital manufacturing source file at the content repository and de-obfuscating the digital manufacturing source file at the viewport; and
selecting the digital manufacturing source file for digital manufacturing.

12. The method as in claim 11 further comprising encrypting the digital manufacturing source file at the content repository and decrypting the digital manufacturing source file at the viewport.

13. The method as in claim 12 wherein the digital manufacturing source file comprises price attributes.

14. The method as in claim 13, further comprising using a purchasing mechanism that is associated with the price attributes of the digital manufacturing source file.

15. The method as in claim 12 wherein the digital manufacturing source file comprises rights attributes.

16. The method as in claim 15, further comprising using a security mechanism that is associated with the rights attributes of the digital manufacturing source file.

17. The method as in claim 12, further comprising viewing multiple visual renderings of the digital manufacturing source file using a manipulating mechanism.

18. The method as in claim 17, further comprising a transforming the digital manufacturing source file to a digital manufacturing instruction file, wherein the digital manufacturing instruction file is associated with a specific model of digital manufacturing device.

19. The method as in claim 18, further comprising using a first transmission mechanism for transferring the digital manufacturing instruction file to a digital manufacturing device server.

20. The method as in claim 19, further comprising using a second transmission mechanism for transferring the digital manufacturing instruction from the digital manufacturing device server to a digital manufacturing device.
